(19) United States
(12) Patent Application Publication
(10) Pub. No.: US 2005/0061260 A1
(43) Pub. Date: Mar. 24, 2005

(54) Male dog garment for use as a diaper

(76) Inventor: Julia Hall, Austin, TX (US)

Correspondence Address: Julia Hall, 13500 Albania Way, Austin, TX, 78729, US

(21) Appl. No.: 10/709,369

(22) Filed: Apr. 29, 2004

Related U.S. Application Data
(60) Provisional application No. 60/481,410, filed on Sep. 24, 2003.

(51) Int. Cl. A01K 23/00

(52) U.S. Cl. 119/869

(57) ABSTRACT

A reusable male dog garment together with a separately attached absorbent pad to serve as a male dog diaper for the collection of urine. The diaper wraps around the dog's body and secured with a Velcro attachment. A specially designed elastic pouch, where the absorbent pad is placed, along with a curved shape of the garment helps prevent twisting of the diaper around the body as well as lateral movement up the back. The absorbent pad may be replaced as necessary.

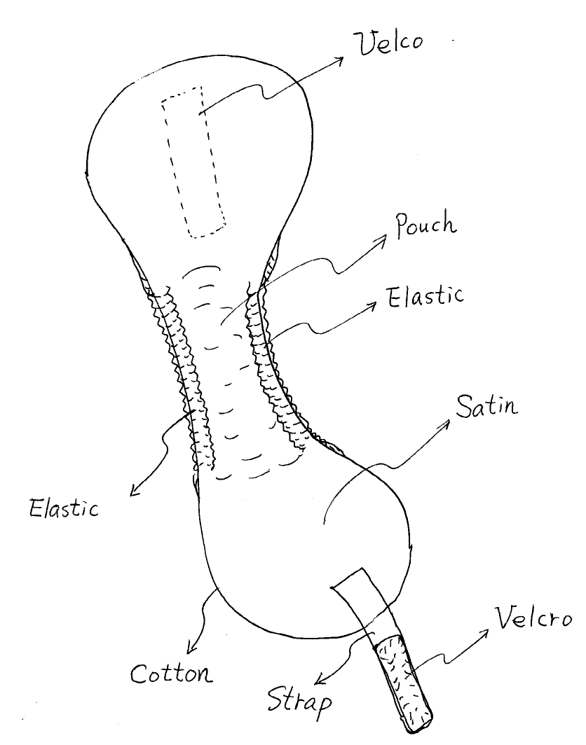

### BRIEF DESCRIPTION OF DRAWINGS

The top view of the Figure illustrates the inner satin lining that will be in contact with the dog's body. The placement of the elastic between the inner satin layer and outer cotton layer is shown. The technique of sewing the elastic creates the pouch that holds the absorbent pad. The Figure also illustrates the placement of the curved sections of the diaper.

### DETAILED DESCRIPTION

This invention consists of a garment for a male dog constructed of an outside cloth material sewed to an inner layer of satin material with a layer of padding in between for comfort. The garment is designed to wrap around the back of a dog and be secured by a single Velcro strap. The satin inner material aids in prevention of hair tangling. The middle portion of the garment consists of a pouch constructed by elastic sewn in between the outside cloth material and inner satin material. This pouch design allows for placement of a disposable absorbent pad in contact with the penis to collect urine. The garment with this absorbent pad together comprises a male dog diaper. The absorbent pad is a separate article not permanently attached to the garment, thus it may be removed as necessary to replace. The absorbent pad is typically attached to the satin inner material of the garment with the adhesive on the back of the absorbent pad. The elastic pouch design better secures the diaper to the dog's body, thus helping to prevent twisting of the diaper around the dog. The material at both ends of the garment is curved to fit the shape of the dog's body allowing freer movement of the hind legs as well as preventing lateral movement of the diaper up the dog's body. The pouch design and curved shape are unique features that improve the performance and distinguishes this dog diaper from simple “belly bands” that are flat and wrap around a male dog. The garment may be manufactured in different sizes to accommodate small to medium sized male dogs and is reusable and machine washable.

1. I claim this garment along with correctly placed, appropriate disposable absorbent pad is used to prevent urination on the floor or furnishings for healthy indoor dogs or dogs with urinary incontinence problems.

2. The garment is designed with a pouch and a curved shape to help prevent the diaper from twisting around the dogs body or up the dogs back.
